(19) United States
(12) Patent Application Publication
(10) Pub. No.: US 2014/0032574 A1
(43) Pub. Date: Jan. 30, 2014

(54) NATURAL LANGUAGE UNDERSTANDING USING BRAIN-LIKE APPROACH: SEMANTIC ENGINE USING BRAIN-LIKE APPROACH (SEBLA) DERIVES SEMANTICS OF WORDS AND SENTENCES

(71) Applicant: Emdadur R. KHAN, SAN JOSE, CA (US)

(72) Inventor: Emdadur R. KHAN, SAN JOSE, CA (US)

(21) Appl. No.: 13/948,738

(22) Filed: Jul. 23, 2013

Related U.S. Application Data
(60) Provisional application No. 61/741,526, filed on Jul. 23, 2012.

(51) Int. Cl. G06F 17/30

(52) U.S. Cl. CPC G06F 17/30424
USPC 707/754

(57) ABSTRACT

Natural Language Understanding (NLU) is a complex open problem. NLU complexity is mainly related to semantics: abstraction, representation, real meaning, and computational complexity. While existing approaches can solve some specific problems, they do not address Natural Language problems in a natural way. This invention describes a Semantic Engine using Brain-Like approach (SEBLA) that uses Brain-Like algorithms to solve the key NLU problem (semantics and its sub-problems).

The main theme of SEBLA is to use each word as an object with all important features, most importantly the semantics. The next main theme is to use the semantics of each word to derive the meaning of a sentence as we do as humans. Similarly, the semantics of sentences are used to derive the meaning of a paragraph. The 3rd main theme is to use natural semantics as opposed to existing “mechanical semantics” used in Predicate logic, Ontology or the like.

### BACKGROUND OF THE INVENTION

The literature on Intelligent Information Retrieval is very rich and hence cannot be covered fully here. However, we have tried to provide a good summary starting from early 2000 and ending in June, 2013. The idea started with the fact that retrieved information from all sources for a query needs to be evaluated to determine relevance with a degree. Content with highest relevance(s) would be provided as the most desired result. This is very good and logical. However, this general approach covered by many researchers has the two following issues:
1. Content need to be retrieved first
2. What is the best way(s) to calculate relevance?

The brief description provided below addresses these, especially item #1. Although numerous works have been done for item #2, it still remains an open problem for which we have provided a solution in “New Art” i.e. this invention as described below under “Description of the Invention”.

It is important to note that the fundamental problem of calculating the relevance is language independent although some language specific features can refine and improve the results.

Existing solution to item #1 takes a small sample from all the retrieved results (thus saving time by not retrieving the full content before evaluation is completed) and determine relevance. However, since reliable relevance still needs to be done (which still remains an open problem and a solution is provided in this invention), it is logical that we focus on the description of item #2 (moreover, once a good relevance is calculated as proposed in this invention, retrieving of all content would not be needed i.e. providing a good solution to problem #1).

Many researchers have proposed various solutions to calculate relevance. Early solutions can be grouped as a solution that is based on key word match in a few paragraphs. Although, this can provide good results in some cases, good relevance cannot really be calculated by using key words. The relationship between words and semantic meanings are keys to determine the relevance. And in doing so, “knowledge representation” became the key issue—i.e. what is real knowledge and how to represent it? Many researchers have proposed to use “ontology” to represent knowledge, which can be considered as the latest approach in representing semantics.

### 1. Literature Review

The brief literature review provided here addresses the two above mentioned issues, especially item #1. Although numerous works have been done for item #2, it still remains an open problem. It is important to note that the fundamental problem of calculating the relevance is language independent although some language specific features can refine and improve the results.

One approach (Approach #1) proposed a solution to item #1 by taking a small sample from all the retrieved results (thus saving time by not retrieving the full content before evaluation is completed) and determine relevance. However, since reliable relevance still needs to be done (which still remains an open problem), it is logical that we focus on the literature review of item #2.

Another approach (Approach #2) describes that while current approaches to ontology mapping produce good results by mainly relying on label and structure based similarity measures, there are several cases in which they fail to discover important mappings. This describes a new approach to ontology mapping by exploiting the increasing amount of semantic resources available online. As a result, there is no need either for a manually selected reference ontology (the relevant ontologies are dynamically selected from an online ontology repository), or for transforming background knowledge in an ontological form.

Yet another approach (Approach #3) discusses a number of important issues that drive knowledge representation research. It begins by considering the relationship between knowledge and the world and the use of knowledge by reasoning agents (both biological and mechanical) and concludes that a knowledge representation system must support activities of perception, learning, and planning to act. An argument is made that the mechanisms of traditional formal logic, while important to our understanding of mechanical reasoning, are not by themselves sufficient to solve all of the associated problems. In particular, notational aspects of a knowledge representation system are important—both for computational and conceptual reasons. Two such aspects are distinguished—expressive adequacy and notational efficacy. The paper also discusses the structure of conceptual representations and argues that taxonomic classification structures can advance both expressive adequacy and notational efficacy. It predicts that such techniques will eventually be applicable throughout computer science and that their application can produce a new style of programming—more oriented toward specifying the desired behavior in conceptual terms. Such “taxonomic programming” can have advantages for flexibility, extensibility, and maintainability, as well as for documentation and user education.

Another approach (Approach #4) mentions that although knowledge representation is one of the central and, in some ways, most familiar concepts in AI, the most fundamental question about it—What is it?—has rarely been answered directly. Numerous papers have lobbied for one or another variety of representation, other papers have argued for various properties a representation should have, and still others have focused on properties that are important to the notion of representation in general. This approach (Approach #4) addresses the question directly. It proposes that the answer can best be understood in terms of five important and distinctly different roles that a representation plays, each of which places different and, at times, conflicting demands on the properties a representation should have.

Another approach (Approach #5) explains that Knowledge is far too complex than propositions. The semantics, relations, and various other unquantifiable stuff make knowledge. It mentions that the Conceptual Graphs are equivalent to Predicate Calculus. It emphasizes that Knowledge representation needs to be mapped to today's Database.

Another approach (Approach #6) presents a new approach to knowledge representation where knowledge bases are characterized not in terms of the structures they use to represent knowledge, but functionally, in terms of what they can be asked or told about some domain. It starts with a representation system that can be asked questions and told facts in a full first-order logical language. It then defines ask-and-tell operations over an extended language that can refer not only to the domain but to what the knowledge base knows about that domain. The major technical result claimed is that the resulting knowledge, which now includes auto-epistemic aspects, can still be represented symbolically in first-order terms. The overall result is a formal foundation for knowledge representation which, in accordance with current principles of software design, cleanly separates functionality from implementation structure.

Another approach (Approach #7) argues the approach by Levesque and Brachman that proposes that general-purpose knowledge representation systems should restrict their languages by omitting constructs which require nonpolynomial worst-case response times for sound and complete classification. Levesque and Brachman also separate terminological and assertional knowledge, and restrict classification to purely terminological information. Approach #7 demonstrates that restricting the terminological language and classifier in these ways limits these “general-purpose” facilities so severely that they are no longer generally applicable. This approach argues that logical soundness, completeness, and worst-case complexity are inadequate measures for evaluating the utility of representation services, and that this evaluation should employ the broader notions of utility and rationality found in decision theory.

Approach #7 suggests that general-purpose representation services should provide fully expressive languages, classification over relevant contingent information, “approximate” forms of classification involving defaults, and rational management of inference tools.

Another approach (Approach #8) proposes that the World Wide Web poses challenges to knowledge representation systems that fundamentally change the way we should design KR languages. They describe the Simple HTML Ontology Extensions (SHOE), a KR language which allows web pages to be annotated with semantics. It also describes some generic tools for using the language and demonstrates its capabilities by describing two prototype systems that use it.

Another approach (Approach #9) expresses web page content in a format that machines can understand, the semantic web provides huge possibilities for the Internet and for machine reasoning. Unfortunately, there is a considerable distance between the present-day World Wide Web and the semantic web of the future. The process of annotating the Web to make it semantic web-ready is quite long and not without resistance. In this paper one mechanism for semanticizing the Web is presented. This system is known as AutoSHOE, and it is capable of categorizing pages according to one of the present HTML semantic representations (Simple HTML Ontology Extensions) by Heflin et al. We are also extending this system to other semantic web representations, such as the Resource Description Framework (RDF). The AutoSHOE system includes mechanisms to train classifiers to identify web pages that belong in an ontology, as well as methods to classify pages within an ontology and to learn relations between pages with respect to an ontology. The modular design of AutoSHOE allows for the addition of new ontologies as well as algorithms for feature extraction, classifier learning, and rule learning.

This system has the promise to help transparently bridge traditional web technology to the semantic web using contemporary machine learning techniques rather than tedious manual annotation.

Another approach (Approach #10) reviews the use of ontologies for the integration of heterogeneous information sources. Based on an in-depth evaluation of existing approaches to this problem, they discuss how ontologies are used to support the integration task. They also ask for ontology engineering methods and tools used to develop ontologies for information integration. They also mention all key issues with ontology integration and associated tools.

Another approach (Approach #11) discusses similar methods for ontology integration.

Another approach (Approach #12) Wolters Kluwer Italy, part of the Wolters Kluwer group on June 2013 announced Cogito that seems to use expanded search words using synonym words for better advanced search results. This is basically an extension of existing advanced search by using richer synonyms.

Use of semantics method is also proposed for the World Wide Web (WWW) page content (the Semantic Web) in a format that machines can understand the web content. The semantic web provides huge possibilities for the Internet and for machine reasoning. Unfortunately, there is a considerable distance between the present-day World Wide Web and the semantic web of the future. Semanticizing the web approach allows for the addition of new ontologies as well as algorithms for feature extraction, classifier learning, and rule learning. This system has the promise to help transparently bridge traditional web technology to the semantic web using contemporary machine learning techniques rather than tedious manual annotation.

Another approach (Approach #13) describes Semantic Reasoner i.e. A semantic reasoner, reasoning engine, rules engine, or simply a reasoner, is a piece of software able to infer logical consequences from a set of asserted facts or axioms. The notion of a semantic reasoner generalizes that of an inference engine, by providing a richer set of mechanisms to work with. The inference rules are commonly specified by means of an ontology language, and often a description language. Many reasoners use first-order predicate logic to perform reasoning; inference commonly proceeds by forward chaining and backward chaining. There are also examples of probabilistic reasoners, including Pei Wang's non-axiomatic reasoning system, Novamente's probabilistic logic network, and Pronto—probabilistic description logic reasoner.

Another approach (Approach #14) A semantic engine extracts the meaning of a document to organize it as partially structured knowledge. For example, you can submit a batch of news stories to a semantic engine and get back a tree categorization according to the subjects they deal with.

Current semantic engines can typically:
categorize documents (is this document written in English, Spanish, Chinese? is this an article that should be filed under the Business, Lifestyle, Technology categories? . . . );
suggest meaningful tags from a controlled taxonomy and assert their relative importance with respect to the text content of the document;
find related documents in the local database or on the web; extract and recognize mentions of known entities such as famous people, organizations, places, books, movies, genes, . . . , and link the document to their knowledge base entries (like a biography for a famous person)
detect yet unknown entities of the same aforementioned types to enrich the knowledge base;
extract knowledge assertions that are present in the text to fill up a knowledge base along with a reference to trace the origin of the assertion. Examples of such assertions could be the fact that a company is buying another along with the amount of the transaction, the release date of a movie, the new club of a football player . . . .

So, it basically uses structured information, not natural sentences.

From this short literature review, it is clear that calculating relevance is dependent on semantics which is dependent on knowledge representation. Among various approaches of knowledge representation, the ontology based approach appears to be more widely used, especially, when we are talking about World Wide Web (WWW) and the Internet. As discussed by various authors, the key issues with ontology based approach are:
1. Developing ontologies
2. Mapping ontologies
3. Integrating various ontologies
4. Developing associated tools
5. Automating ontology development using Machine Learning (ML) techniques
6. “mechanical” nature of the semantic by ontology representation

And of course, manual and semi-automated development of ontologies for over 3 billion websites on the WWW is impractical. Such approach will be good for some specific web applications. Besides, “mechanical semantic” and “mechanical reasoning” will significantly limit the calculation of relevance. The other key technique for relevance is statistical techniques including Maximum Likelihood. While this approach provides excellent results for predicting the next word(s) [e.g. when words are typed in a search field in a search engine], it is not effective in calculating semantics.

Thus, the best existing methods are limited by “mechanical semantics” and its scalability. This affects almost all applications of NLU including Information Retrieval, Q & A, Summarization, Language Translation and Conversational Systems.

Accordingly, we propose an alternate approach using semantic representation for each word and then deriving semantics for each sentence in an automated way using brain-like and brain-inspired algorithms as stated and explained in this invention under “New Art”. It calculates relevance using semantics and Natural Language Understanding (NLU). Our approach overcomes all the limitations mentioned with the existing approaches as further described below under Detailed Description. As humans, we automatically understand semantics when we read a content; no special tag or representation is needed to add on the content to derive semantics. Our approach uses the same way, and thus there is no need to re-write the website to add ontology.

It is important to note that our core algorithms are independent of language. However, some language specific features can further improve the results.

### BRIEF SUMMARY OF THE INVENTION

While traditional approaches to Natural Language Understanding (NLU) have been applied over the past 50 years, results show insignificant advancement, and NLU, in general, remains a complex open problem. NLU complexity is mainly related to semantics: abstraction, representation, real meaning, and computational complexity. In this invention, first we argue that while existing approaches are great in solving some specific problems, they do not seem to address key Natural Language problems in a practical and natural way. Then we propose a Semantic Engine using Brain-Like approach (SEBLA) that uses Brain-Like algorithms to solve the key NLU problem (i.e. the semantic problem) as well as its sub-problems.

The main theme of our approach is to use each word as an object with all important features, most importantly the semantics. In our human natural language based communication, we understand the meaning of every word even when it is standalone without any context. Sometimes a word may have multiple meanings which get resolved with the context in a sentence. The next main theme is to use the semantics of each word to develop the meaning of a sentence as we do in our natural language understanding as humans (FIG. 1 and FIG. 2).

At the word level, the key question we have addressed is how to represent the semantics for each word and how to associate appropriate World Knowledge (WK) with each word. By using the representation and semantic feature of each word, along with the World Knowledge associated with each word, the meaning of a sentence is derived by applying the grammar of the language and appropriate rules to combine words. Key features of the words and appropriate rules to combine them are learned/refined using large text corpora and machine learning algorithms. The inference engine (Intelligent Agent) will determine the meaning of a sentence by using the word semantics, appropriate rules to combine the words in a sentence and the World Knowledge (WK).

Our Brain-Like approach using SEBLA is expected to work much better as semantics for a sentence is automatically derived from words in the sentence. There is no need to create ontology and map ontology which are two key difficult problems in existing ontology based knowledge representation. The knowledge representation in SEBLA is through the representations of the words and the rules to combine them. In fact, SEBLA knowledge representation is sort of a knowledge framework that can be learned/refined for a specific domain using respective text corpora.

Use of semantics would add “biological reasoning” and minimize “mechanical reasoning” used in existing formal logic.

It is important to note that if and when needed, ontology can be derived from SEBLA's knowledge representation; thus allowing integration of SEBLA with existing ontology based knowledge representation.

Use of our Brain-Like approach ensures “human-like language processing and understanding”, a general goal of NLP (Natural Language Processing)/NLU (Natural Language Understanding) which has not yet been accomplished. A full NLU system would be able to:
1. Paraphrase an input text.
2. Translate the text into another language.
3. Answer questions about the contents of the text.
4. Draw inferences from the text.

Although NLP has made serious inroads into accomplishing goals 1-3, the fact that existing NLP systems cannot, of themselves, draw inferences from text, NLU still remains the goal of NLP. We believe, SEBLA would achieve goal 4 and also better achieve goals 1-3.

Accordingly, SEBLA would enable many existing applications to work much better as well as enable many new applications in the NLU domain including Conversational Systems, Question and Answer Systems, Intelligent Information Retrieval, Intelligent Search, Reliable Language Translation, Summarization and Drawing Inference (e.g. Business Intelligence).

As mentioned, an Intelligent Agent is used along with the SEBLA based NLU to perform all the related tasks, namely, deriving the semantics of the words in a query using Brain-Like approach, deriving the semantics of the query sentence, understanding the query sentence, taking appropriate action based on the understanding of the query sentence, accessing all relevant desired information and then
a. (for Information Retrieval and Q & A) filtering unrelated information from the retrieved information, assembling filtered retrieved information and presenting the assembled information in a succinct and logical way to the user. For Q & A, the information presented will be the answer i.e. very succinct. In case of IIR, it can be a small set of relevant information.
b. (for summarization) filtering unrelated information from the retrieved information, assembling filtered retrieved information and creating a good summary.
c. (for drawing inference) summarization as well as adding sentences to express the inference based on the retrieved content (e.g. in case of Business Intelligence).

FIG. 1(b) shows an Intelligent Information Retrieval (IIR) system using SEBLA. As well known, the information retrieval through existing search engines is mainly based on string search. Thus, such engines produce thousands of results and human knowledge & intelligence are needed to retrieve the desired information from the search results, thus limiting its usage to mainly the experienced and educated users. There are THREE key issues with the current approaches:
a. String search results contain many undesired and unrelated results.
b. String search results may not contain the desired results and user may need to do multiple searches by various search word combinations.
c. String search results may NOT contain the desired information even after trying major key word combinations as a user may skip key words of similar meaning

Our proposed approach in IIR using SEBLA addresses these key problems in TWO broad ways:
A. Retrieve expanded and more related information and then get most desired information by filtering.
B. Retrieve far less but more related and appropriate information (via semantics) and then get more refined desired information.

For approach A (FIG. 1(b)), we have, the following key tasks:
a. in the query sentence/string to understand the meaning of each word and sentence.
b. generate all related sets of query strings using semantic meaning of each word and sentence (thus generating many more appropriate search results related to the input words and sentences).
c. extract the most appropriate and related results from the extended search results. This is achieved by employing the rendering component of IIR. NLU using SEBLA is also used in this rendering step to determine the most relevant information (FIG. 1(c)).

Approach B and associated tasks are described in detail under the “Detailed Description of the Invention” below.

### BRIEF DESCRIPTION OF THE DRAWINGS

FIG. 1(a) depicts Semantic Engine Using Brain-Like Algorithm—Training phase using large Natural Language Sentence Corpora and Machine Learning Algorithms.

FIG. 1(b) depicts Semantic Engine Using Brain-Like Algorithm—Recall phase. Also showing complete retrieval of desired information. The Intelligent Agent (IA) shown is for Intelligent Information Retrieval (IIR). Similar IA is used for Question and Answer System, Language Translation or other similar systems/applications. Note—continuous refinement is done using similar algorithm as shown in the training phase.

FIG. 1(c) depicts details of the block in FIG. 1(b) that shows Rendering Using SEBLA and/or Other Methods And Assembling the Most Desired Content.

FIG. 2 depicts the details of the SEBLA (Semantic Engine using Brain-like Algorithms).

FIG. 3 depicts the sample tables for (a) Function Words and (b) World Knowledge (WK).

FIG. 4 depicts how semantics of multiple sentences are calculated. If Summarization is calculated, the feedback loop is used for further refinement when needed.

### DETAILED DESCRIPTION OF THE INVENTION

The Semantic Engine using Brain-Like Approach (SEBLA) has two phases:
a. “training” phase and
b. “recall” phase.

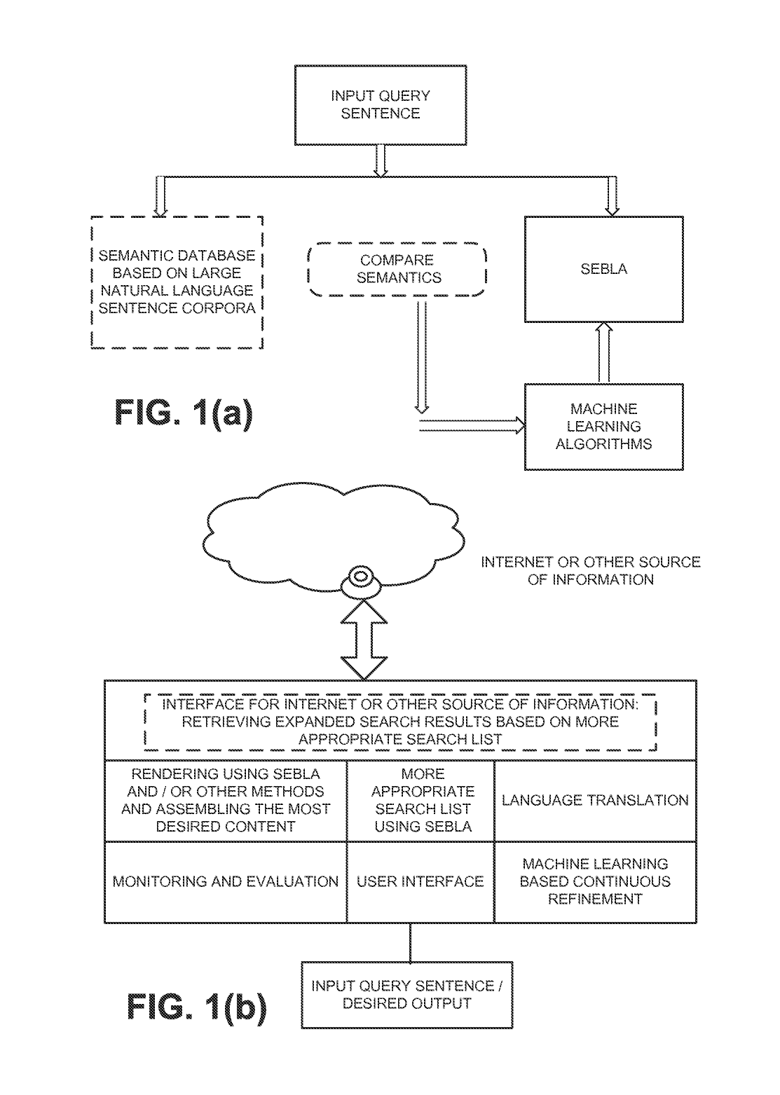

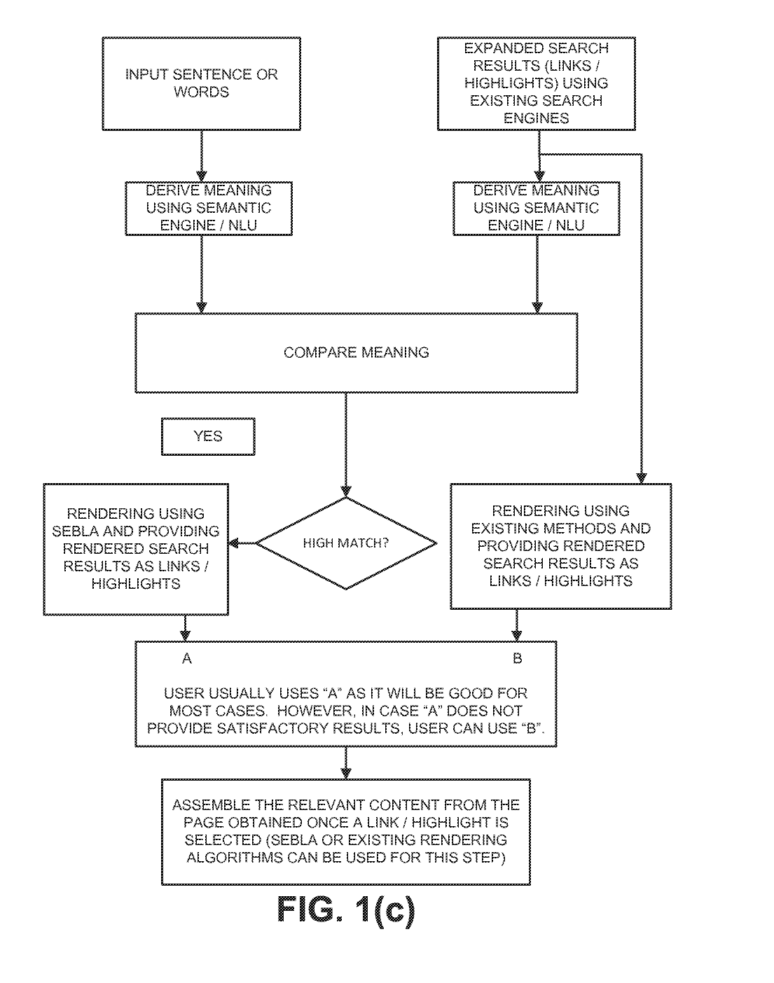

The “recall” phase can also have the on-line training as a continuous learning process, mainly for refinement. FIG. 1(a) shows the training phase. An input sentence (or words) is provided to both SEBLA and Semantic database (SD). SD is formed by taking a natural language sentence corpora and defining semantics by some Natural Language experts. The format of the semantics may vary. Since SEBLA derives semantics of a sentence using semantics of words and natural language grammar, ideally a relatively small SD is needed. In some cases—e.g. for small vocabulary applications, an SD may not be needed at all. So, SD is mainly used for refinement of SEBLA semantics. Since a natural language corpora may have trillions of sentences (e.g. Google Trillion Sentence database [NY2010]), manually creating Semantics for all sentences in such a large corpora is a daunting task. Hence, this invention recommends to use a small size SD to ensure that SEBLA has a good start and then use just SEBLA itself and (when needed) an SD for refinement. However, instead of manually creating a large SD, all sentences for which SEBLA correctly derived semantics during its Recall phase over time, can be automatically added to the SD. This can be done by properly monitoring SEBLA's performance on a continuous basis.

For any incorrect performance of SEBLA, it will try to re-train itself. Retraining includes fine tuning of the semantics of the words as appropriate. A large language corpora is still useful in three major ways: to refine and enhance the World Knowledge (WK), to refine and enhance Function words of a word, and to help better use of the grammar of the language.

The Machine Learning (Ml) box shown in FIG. 1(a) and FIG. 1(b) can use almost any machine learning algorithm as appropriate.

The main theme of our approach is to use each word as object with all important features, most importantly the semantics. In our human natural language based communication, we understand the meaning of every word even when it is standalone without any context. Sometimes a word may have multiple meanings which get resolved with the context in a sentence. The next main theme is to use the semantics of each word to develop the meaning of a sentence as we do in our natural language understanding as humans.

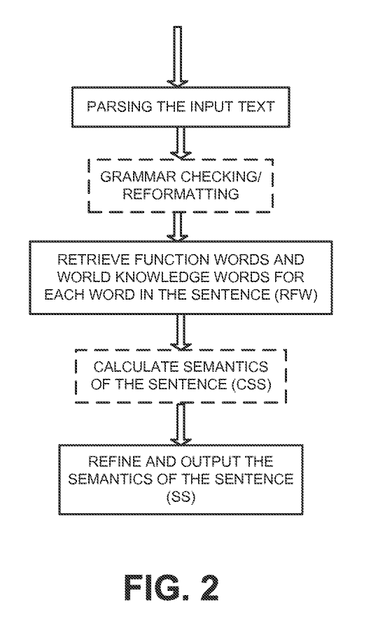

At the word level, the key question we have addressed is how to represent the semantics for each word and how to associate appropriate world knowledge with each word. By using the representation and semantic feature of each word, along with the world knowledge associated with each word, the meaning of a sentence is derived by applying the grammar of the language and appropriate rules to combine words. Key features of the words and appropriate rules to combine them are learned/refined using large text corpora and machine learning algorithms. The inference engine (Intelligent Agent) will determine the meaning of a sentence by using the word semantics and appropriate rules to combine the words in a sentence. FIG. 2 shows SEBLA's key blocks. Before describing the Intelligent Information Retrieval (IIR) system using SEBLA (FIG. 1(b)), we describe details of SEBLA.

The input text (can also be generated by a Speech Recognition Engine, ASR) is parsed into word categories like noun, verb, pronoun, adjective, etc. This is done by the block named Parsing the input Text. The parsed words are then further refined and checked by grammar rules using the block Grammar Checking/Reformatting. Unnecessary words like “the”, “a” are removed as they do not carry much value for the “core” semantic meaning

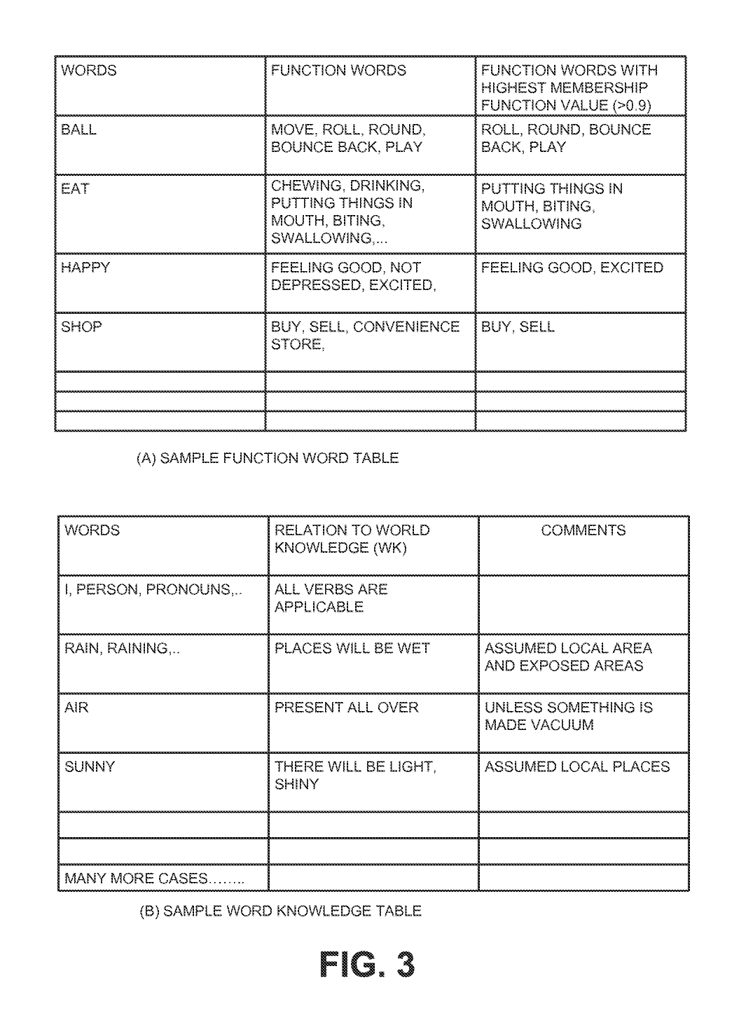

The RFW (Retrieve Function words and World Knowledge (WK) words for each word in the sentence) block retrieves 2 types of words for each word in the refined sentence. These words are retrieved form libraries of Function Words and WK words. A sample of such word libraries/tables are shown in FIG. 3.

The output of RFW is then processed by CSS (Calculate Semantics of the Sentence) block. The algorithm for such semantic calculation is described below.

### Algorithm to Calculate Semantics:

### A. Sentence Level

We consider each parsed word in the refined sentence. For each of such words,
a) Get the Function words
b) Get the World Knowledge (WK) words

E.g. for the word “ball”, the function words are {ball, move, roll, round, play.} as shown in FIG. 3(a).

Similarly, the function word for “go” is {go, move, not static, . . . } and the function word for “school” is {school, study, student, teacher, learn}. We can add other related words which are usually implied—e.g. for “school”, “a place to” {study}, a place where {students} go etc. But in general a short list of function words suffices and makes it simpler. Note that the word itself is included in its Function word. This can be done in the WK and thus, we may not include the word itself in its Function word.

Now let's consider the sentence,
“I go to school”. For semantic retrieval, we will use “I go school” as simplifying the verb phrase (VP) “go to school” to “go school” helps. This is a “declarative” type sentence. From language standpoint, the word “I” (noun Phrase, NP) is the subject. “go” is the verb which is part of VP “go school” where “school” is a noun. Now, we need to apply the function words to calculate the semantics of the first two words i.e. “I go”. In doing so, we first take the Function words for “I” and Function words for “go”. Thus, we have,
   I {person, he, she, living object, . . . |eat, go, fly, all verbs} go {move, walk, run, . . . }. Then, we take only the subject words for “I” and verb words for “go”, which yields the following semantics,

I {person} go {move, walk, run, . . . } (1)
Similarly, the semantics of the sentence
   “I go to school” is

I {person} go {move, walk, run, . . . } school {study, student, teacher, learn} (2)

Note that the main words are there to visualize it better. The real semantics is represented by all words under the curly braces { }.

Consider another sentence,
“I open door”, the semantics of which is

I {person} open {open, unlock, push, pull, . . . } door {a thing that blocks, close, open, move, . . . } (3)

We can now ask a question like
“I am doing what”. The semantics of this sentence is

I {person} doing {unlock, push, pull, open . . . all verbs as included in WK} what {question} (4)

A match operation between equations (3) and (4) will yield

I {person} doing-open {unlock, push, pull, . . . } what-door {question} (5)
The match between “doing” and “open” is true as “doing” includes all verbs as included in World Knowledge (WK).

Note: For other words (i.e. without an auxiliary verb) that imply open (e.g. ajar), the answer will be same as “ajar” would be included in the Function word of “open”. In this case, we do not need to use the WK but it won't hurt even if it is in the WK.

Equation (5) can then be processed to yield the answer
“I am opening the door”, after some refinement using grammar.

To better explain this, let's use an invalid sentence, e.g.
“Door walks” which is not valid as in the Function words for “door”, “walk” is not there. Besides, “door” is not a living thing and hence it will not be supported by the WK (further explained below under “World Knowledge” below). So, the semantics of this would be NULL or a question mark “?”.

Another example will make this a bit more clear. Consider the following:

“Maharani serves vegetarian food.” (6)
Semantics represented by existing methods, e.g. Predicate Logic, is Serves(Maharani, Vegetarian Food) and
Restaurant(Maharani)

Now, if we ask

“is vegetarian dishes served at Maharani?” (7)
the system will not be able to answer correctly unless we also define a semantics for “Vegetarian Dish” or define that “food” is same as “dish” etc. This means, almost everything would need to be clearly defined (which is what is best described by “mechanical semantics”). But with SEBLA based NLU, the answer for the above question will be “Yes” without adding any special semantics for “Vegetarian Dish”. The “mechanical semantics” nature becomes more prominent when we use more complex predicates e.g. when we use universal and existential quantifiers, and/or add constructs to represent time.

Our SEBLA based approach shown above for “declarative” sentences will work in a similar way for other types of English (and other languages) sentences including
“imperative”, “yes/no”, “wh-structure”, and “wh-nonsubject-structure”.

NOTE:
It is important to note that ML (Maximum Likelihood) based performance commonly used in prediction (e.g. when one types words in a search field on a search engine it shows the next word(s) automatically) will be improved with natural semantics. Currently, mainly ML (and sometimes other techniques including existing semantics methods) is used for prediction. By using proposed more natural semantics (e.g. using SEBLA), the meaning of the typed words will be more clear; thus helping better prediction of the next word(s). It will also help using natural sentences in the search field than special word combinations, e.g. when using advanced search.

However, for more complex cases, we will have issues like “which word(s) of the Function words to take in calculating semantics”. For this we use Membership function of the Function words so that word(s) with the highest membership function will be picked (FIG. 3(a)). Then we use WK words to further refine the semantics and reject function words not very appropriate. For some cases, words with highest membership value may not provide optimal semantics as the WK words may dominate and Function words with lower membership value may produce optimal semantics.

The membership values can be refined using large Language corpora as well as semantics corpora. This is also true for WK i.e. it can be refined/enhanced by learning via language and/or semantics corpora. In general, WK is in the WK table. E.g. person, he, she, etc. are in general live people. But some of them might be dead. In such cases, there need to be facts about that either in the Fact database or WK database. So, if John is alive, then
“John plays ball” can be valid. WK knows that all live people are associated with all verbs etc.

### More Complex Sentences:

SEBLA based approach also works with more complex sentences. Consider the sentence,

“I am trying [VP (Verb Phrase) to find a flight that goes from Pittsburgh to Denver after 2 pm” (8)

Here, the basic idea is to use the sentence starting at top level and classify it as having a Noun Phrase (NP) and Verb Phrase (VP). Then, deal with the complexity of the VP using similar way as described above. So, the first level semantics is
I {person} trying {doing something, working on,} to find {looking, trying to look, . . . },
as the main verb of the VP “find a flight that goes from Pittsburgh to Denver after 2 pm” is “find” or “to find”.

Now, we can focus on “a flight that goes from Pittsburgh to Denver after 2 pm”.

This reduces to “flight goes” as the rest i.e. “from Pittsburgh to Denver after 2 pm” is from a city to another city after “time” 2 pm. The semantics for the words before the cities is

I {person} trying {doing something, working on, trying . . . } to find {looking, trying to look, . . . } flight {a plane going from one city to another, . . . } (9)

The semantics of the rest of the sentence is sort of constant up to the “time 2:00 pm”. The WK can be used to handle the time if a question related to time is asked. Now, if we ask
“what the person is trying to do”,
the answer will be “the person is trying to find a flight” and then add “from Pittsburgh to Denver after 2 pm”. This is because semantics of the first few words in the question will match/partially match (with high confidence) with the fact. The semantics of the last word “do” in the question, will be checked against the word “to find” in the fact sentence. By WK, “do” goes with almost all verbs. Hence, it will match with “find” or “to find”.

But if the question is
“the person is trying to find a flight from which city to which city”, then the system will look into “from” and “to”, as the semantics of the question up to which city will match with the semantics of the sentence up to “from” etc. as explained above.

In case there are multiple similar facts and hence, possible, multiple matches, we can have various approaches to resolve that:
a. Provide all possible answers for which match is high.
b. Ask user more questions to help determine the best answer.
c. Use the discourse or relationships of the semantics of some previous words or some words after the key word(s) or previous/later sentences (see case B below).
d. Some other approaches.

In summary, the existing “syntactic parsing” techniques can be used for parsing as needed BUT the Function words will help the missing gap of existing “semantic parsing” that uses “mechanical semantics”. The key challenge is to properly defining and learning/refining the Function words of a word. Function words inherently describe the meaning or semantics and thus avoid separately defining semantics using existing approaches like Predicate Logic or Ontology.

### Algorithm to Calculate Semantics:

### B. Paragraph Level

Similar algorithms can be used in calculating semantics for multiple sentences and paragraphs. However, some modifications are needed for the following reasons:
1. Within a sentence, words are used in a constrained way using grammar. But between sentences there is no such grammar.
2. Usually, a group of sentences carry a theme within a context and there are relations between sentences.

Thus, to calculate the semantics between sentences, we will use word semantics as before BUT with some modifications. This is also true for a single long sentence segmented by comma, semicolon, “but”, “as” and the like. We also need to take account for “discourse” i.e. coherence or co-reference to words in previous sentences. There are some good existing solutions mainly for a small domain problem. But, in general Computational Discourse (CD) in natural language is an unsolved problem. However, with our SEBLA based scheme, the CD problem can be solved to a good extent for large domains.

In calculating semantics in a long sentence, the previous, next and other words can further influence/refine the semantics. For convenience, we have included this aspect in calculating semantics of multiple sentences.

First, let's consider only 2 sentences. As before, we will generate semantics for sentence 1 (S1) and sentence 2 (S2). But instead of finding a match to get an answer (as shown above for Q & A), we need to do a match to see any relationship between S1 and S2. If there is some relationship it will help CD which in turn will help summarization or drawing inference. Any possible relationship between S1 and S2 is calculated by extracting the core semantics of both sentences. Consider the following 2 sentences:

John hid Bill's car keys (S1). He was drunk. (S2) (10)

The semantics of the sentences are
John {person} hid {hide, remove, putting in secret place, doing not a good thing, doing a bad thing, . . . }.
He {person} drunk {drunk, abnormal, under influence, bad, doing a bad thing, not doing a good thing, not in good state . . . }

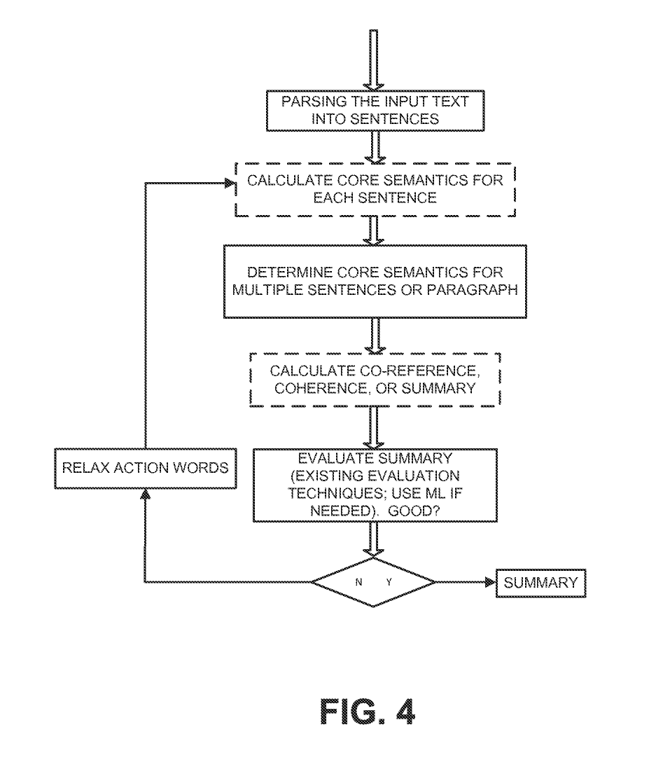

Here, via matching, “he” is related to John (co-reference), and “hid” is related to “drunk”. So, S2 sort of explains the action in S1 (coherence). If we are looking for just coherence, we can take the core semantics of S1 and S2. The core semantic words of S1 is {hid keys} and the same for S2 is {was drunk} or just {drunk}. If we use the Function words for these word pairs, “drunk” will match with “hid” as shown above, and thus, the system will find the relationship between S1 and S2. The core semantic words are basically verb (action) and object of the action. FIG. 4 shows key steps in calculating semantics of multiple sentences and paragraphs.

Now let's consider semantics of a paragraph. Consider the following paragraph:

The Intelligent Internet (IINT) will take the Internet to a new level (S1). It will allow existing as well as significant number of new users to enjoy the existing and various new benefits of the Internet (S2). IINT will affect their lives in a positive way with Economic, Social, Cultural and other developments globally (S3) (11)

The core semantics of each sentences are as follows:

S1→{take internet} 12a

S2→{allow enjoy} 12b

S3→{affect lives} 12c

Using the Function words in (12), we see relation between “internet” & “enjoy” (12a and 12b) and “internet” & “lives” (12a and 12c) and “enjoy” & “lives” (12b and 12c). Thus, the core semantics of these sentences can be represented as

{internet, enjoy, lives} (13)

Now, we can derive the summary by using these core semantic words, matching with input sentences and compressing them, yielding

The Intelligent Internet (IINT) will allow existing as well as significant number of new users to enjoy the existing and various new benefits of the Internet. IINT will affect their lives in a positive way with Economic, Social, Cultural and other developments globally (14)

The first sentence is dropped as the action word “take” did not match with any similar words and hence not in (13). However, the first sentence can be added if evaluation (see below) provides a low score to the “summary” (i.e. for cases where dropping a sentence(s) may lower the score too much. In general, a sentence not having any action does not belong to the “summary”.

This may not be the best summary. In general, summarization is an iterative process—take minimum words for action(s) and associated object(s) and find the core semantics. Then calculate the summary. Then evaluate the summary using some evaluation techniques (including existing standard evaluation techniques e.g. ROGUE, Pyramid Method). If the evaluation score is low, relax the “action words” i.e. take more action words and associated objects and repeat the process. E.g. if we take both action words “allow” and “enjoy” in S2, then “allow” will match with “take” in S1. Then we will have S1 in the summary etc. Additionally, machine learning (ML) can be used to further improve the summarization. Besides, simple reduction can also be used e.g. “as well as” in S1 can be replaced with “and”.

The same process can be applied to more sentences i.e. multiple paragraphs as paragraphs are joining of multiple sentences. If there is no good semantics between two paragraphs, then those two paragraphs are talking about different things and cannot be summarized i.e. we need to keep them as is or use higher level semantics (e.g. in drawing inferences).

SEBLA can help all key tasks in Summarization including general summarization, question specific summarization, and creating abstracts. SEBLA can also be used for many other NLP applications e.g. Information Extraction (including temporal and event processing), Question & Answer (including factoid & more general), Drawing Inference, Machine Translation, Conversational System and more.

Note that existing schemes for most of such applications can also be used in combination with the proposed methods to further refine/enhance as appropriate.

To further explain the concept, we have described an Intelligent Information Retrieval (IIR) system in FIG. 1(b) using SEBLA. It is important to note that an Intelligent Agent is used along with the SEBLA based NLU to perform all the related tasks, namely, deriving the semantics of the words in a query using Brain-Like approach, deriving the semantics of the query sentence, understanding the query sentence, taking appropriate action based on the understanding of the query sentence, accessing all relevant desired information and then
a. (for Information Retrieval and Q & A) filtering unrelated information from the retrieved information, assembling filtered retrieved information and presenting the assembled information in a succinct and logical way to the user. For Q & A, the information presented will be the answer i.e. very succinct. In case of IIR, it can be a small set of relevant information.
b. (for summarization) filtering unrelated information from the retrieved information, assembling filtered retrieved information and creating a good summary.
c. (for drawing inference) summarization as well as adding sentences to express the inference based on the retrieved content (e.g. in case of Business Intelligence).

[Note: An Intelligent is needed for other similar applications like Q&A, Language Translation, and Conversational System].

The information retrieval through existing IR and search engines are mainly based on string search. Thus, the search process needs to deal with many data to find matches. And all matched data are extracted even though many data are not relevant and desired. Accordingly, such engines produce many (often thousands of) results, and human knowledge and intelligence are needed to retrieve the desired information from such search results. This requirement usually limits the usage of search engines to experienced and educated users. There are FOUR key issues with the current approaches:
a. Search process needs to deal with very large data.
b. String search results contain many undesired and unrelated results.
c. String search results may not contain the desired results and user may need to do multiple searches by various search word combinations.
d. String search results may NOT contain the desired information even after trying major key word combinations as a user may skip key words of similar meaning.

The semantic capability of SEBLA addresses these issues in TWO broad ways:
A. Retrieve expanded and more related information and then get most desired information by filtering.
B. Retrieve far less but more related and appropriate information and then get more refined desired information.

Approach in A (FIG. 1(b)) is useful when string search data is not too large and conventional search engines can be used. The key steps using approach A are:
1. In the query sentence/string to understand the meaning of each word and sentence.
2. Generate all related sets of query strings using semantic meaning of each word and sentence (thus generating lot more appropriate search results that are related to the input words and sentences).
3. Extract the most appropriate and related results from the extended search results. This is achieved by employing the semantics and rendering (FIG. 1(c)).

Many words have multiple synonyms. By understanding the semantics of each word, a complete (or nearly complete) set of synonyms will be generated. Without semantic meaning, only limited predefined synonyms can be used as done for some words in existing search engines. This is also true for sentences. By understanding each search sentence, corresponding equivalent search sentences and corresponding words will be generated. The sentence level semantics will be used to refine the word list to help reduce search results when submitted to search engines.

If a user only presents search key words and no sentences, then, using NLU, a set of most relevant search words will be generated. This is be done by creating different word combinations (including all synonyms), deriving the semantic meanings, and then appropriate filtering to derive the most appropriate set of search word combinations.

If a user presents sentences, then similar sentences using synonym words will be generated by keeping the context same. Then a corresponding set of key words will be generated. This is important as existing search engines mainly work on string search and do not depend on the meaning of the sentences or words. However, they do strongly consider word combinations.

Approach in B is useful when string search data are very large and conventional search engines can take too long. This approach is more appropriate for Big Data. The key steps using this approach are:
1. In the query sentence/string to understand the meaning of each word and sentence.
2. Calculate the semantics of each title/indexed item (targets from the standard string based match with the query but before retrieval of the associated content) and calculate semantic matching or overlap of the query with each target. Then select the target (s) with high semantic matching. In this case a new search method using semantic matching (instead of string matching) will be needed. Searching with semantic meaning will retrieve very appropriate and much less information.
3. Extract the most appropriate and related results from the search results in step #2.
   NOTES:
      (a) Approach A and B can also be combined to get more appropriate results for some applications.
      (b) Search algorithm of existing search engines may be modified to retrieve not all string matched content but retrieve contents only with high semantic match after doing a semantic match with the potential targets.

What is claimed is:

1. A method of facilitating retrieval of content from the Internet (or other content source) using Natural Language query(ies), deriving the semantics of the words in a query using Brian-Like approach, deriving the semantics of the query sentence, understanding the query sentence, taking appropriate action based on the understanding of the query sentence, accessing all relevant desired information, filtering unrelated information from the retrieved information, assembling filtered retrieved information and presenting the assembled information in a succinct, logical and user friendly way to the user comprising the steps of:
Establishing a bi-directional communication link between the Internet or other source of information and a user;
Receiving via said bi-directional communication link, a voice or typed sentence corresponding to a Natural Language Query;
Deriving the semantic meaning of each word;
Deriving the meaning of the query sentence;
Understanding the query sentence;
Deriving appropriate action based on the understanding of the query sentence;
Performing said actions and accessing all relevant desired information;
Filtering unrelated information from the retrieved information;
Assembling filtered retrieved information;
Presenting the assembled information in a succinct, logical and user friendly way to the user using the said bi-directional communication link;
The information finally presented can be specific answer to a question, a related succinct search results, a specific information extraction, summary of a desired information, an inference of the desired information or any other types of desired information that can be processed by the Semantic Engine using Brian-Like approach and an Intelligent Agent;
